(19) United States
(12) Patent Application Publication
(10) Pub. No.: US 2014/0046888 A1
(43) Pub. Date: Feb. 13, 2014

(54) NAVIGATION SYSTEM WITH COLLECTION MECHANISM AND METHOD OF OPERATION THEREOF

(71) Applicants: Aliasgar Mumtaz Husain, Milpitas, CA (US); Frederic Paul Julien, Pleasanton, CA (US); Thu-Phuong Tuong Do, Mountain View, CA (US)

(72) Inventors: Aliasgar Mumtaz Husain, Milpitas, CA (US); Frederic Paul Julien, Pleasanton, CA (US); Thu-Phuong Tuong Do, Mountain View, CA (US)

(73) Assignee: TELENAV, INC., Sunnyvale, CA (US)

(21) Appl. No.: 13/570,201

(22) Filed: Aug. 8, 2012

(51) Int. Cl. G06F 17/30

(52) U.S. Cl. 706/46; 707/E17.044

(57) ABSTRACT

A method of operation of a navigation system includes: determining a social indicator for identifying a social relationship; adjusting a collection scope based on the social indicator for monitoring a user's behavior; collecting a user's information based on the collection scope; and generating a notification based on the user's information for displaying on a device.

### TECHNICAL FIELD

The present invention relates generally to a navigation system, and more particularly to a system with collection mechanism.

### BACKGROUND ART

Modern portable consumer and industrial electronics, especially client devices such as navigation systems, cellular phones, portable digital assistants, and combination devices, are providing increasing levels of functionality to support modern life including location-based information services. Research and development in the existing technologies can take a myriad of different directions.

As users become more empowered with the growth of mobile location based service devices, new and old paradigms begin to take advantage of this new device space. There are many technological solutions to take advantage of this new device location opportunity. One existing approach is to use location information to provide navigation services such as a global positioning system (GPS) for a car or on a mobile device such as a cell phone, portable navigation device (PND) or a personal digital assistant (PDA).

Location based services allow users to create, transfer, store, and/or consume information in order for users to create, transfer, store, and consume in the “real world.” One such use of location based services is to efficiently transfer or route users to the desired destination or service.

Navigation systems and location based services enabled systems have been incorporated in automobiles, notebooks, handheld devices, and other portable products. Today, these systems aid users by incorporating available, real-time relevant information, such as maps, directions, local businesses, or other points of interest (POI). The real-time information provides invaluable relevant information.

However, a navigation system without collection mechanism has become a paramount concern for the consumer. The inability decreases the benefit of using the tool.

Thus, a need still remains for a navigation system with collection mechanism. In view of the increasing mobility of the workforce and social interaction, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a navigation system including: determining a social indicator for identifying a social relationship; adjusting a collection scope based on the social indicator for monitoring a user's behavior; collecting a user's information based on the collection scope; and generating a notification based on the user's information for displaying on a device.

The present invention provides a navigation system, including: a factor module for determining a social indicator for identifying a social relationship; a scope module, coupled to the factor module, for adjusting a collection scope based on the social indicator for monitoring a user's behavior; a collection module, coupled to the scope module, for collecting a user's information based on the collection scope; and a notification module, coupled to the collection module, for generating a notification based on the user's information for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a navigation system with collection mechanism in an embodiment of the present invention.

FIG. 2 is an example of the navigation system collecting a user's information based on a collection scope.

FIG. 3 is an example of the monitoring factor.

FIG. 4 is an exemplary block diagram of the navigation system.

FIG. 5 is a control flow of the navigation system.

FIG. 6 is a flow chart of a method of operation of the navigation system of FIG. 1 in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e., a position of a user.

In an alternative embodiment, navigation information is presented by longitude and latitude related information. In a further embodiment of the present invention, the navigation information also includes a velocity element including a speed component and a heading component.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

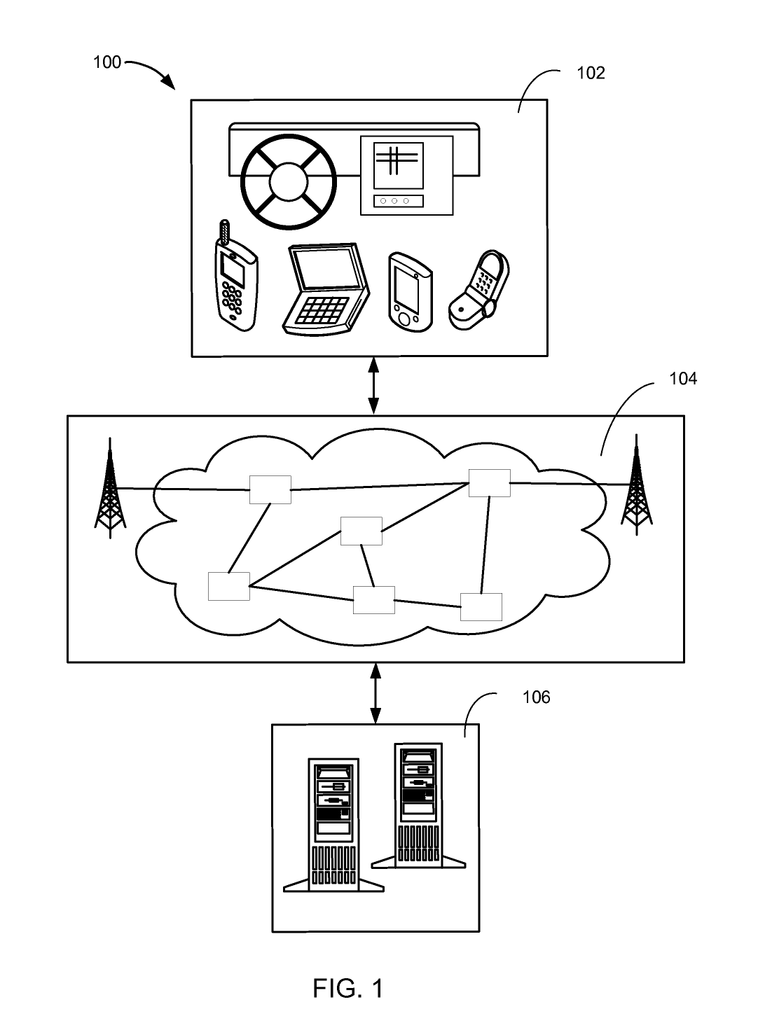

Referring now to FIG. 1, therein is shown a navigation system 100 with collection mechanism in an embodiment of the present invention. The navigation system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, a notebook computer, automotive telematic navigation system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the navigation system 100 is described with the first device 102 as a mobile computing device, although it is understood that the first device 102 can be different types of computing devices. For example, the first device 102 can also be a non-mobile computing device, such as a server, a server farm, or a desktop computer. In another example, the first device 102 can be a particularized machine, such as a mainframe, a server, a cluster server, rack mounted server, or a blade server, or as more specific examples, an IBM System z10™ Business Class mainframe or a HP ProLiant ML™ server.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102. Another example, the second device 106 can be a particularized machine, such as a portable computing device, a thin client, a notebook, a netbook, a smartphone, personal digital assistant, or a cellular phone, and as specific examples, an Apple iPhone™, Palm Centro™, or Moto Q Global™.

For illustrative purposes, the navigation system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the navigation system 100 is shown with the second device 106 and the first device 102 as end points of the communication path 104, although it is understood that the navigation system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

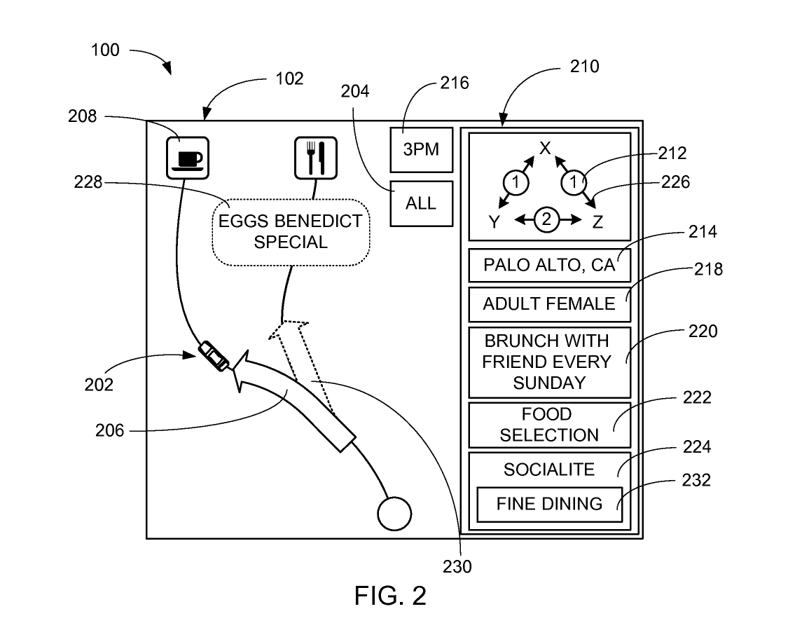

Referring now to FIG. 2, therein is shown an example of the navigation system 100 collecting a user's information 202 based on a collection scope 204. For clarity and brevity, the discussion of the present invention will focus on the first device 102 displaying the result generated by the navigation system 100. However, the second device 106 of FIG. 1 and the first device 102 can be discussed interchangeably.

The user's information 202 is defined as the facts pertaining to the use of the first device 102. For example, the user's information 202 can include a user's behavior 206, such as places searched for and driven by the user of the first device 102, advertisement interaction by the user, user's driving decisions, or a combination thereof. For another example, the user's information 202 can include a category of interest 208 preferred by the user of the first device 102. For a specific example, the category of interest 208 can represent a type of cuisine, activity, entertainment, or a combination thereof.

The collection scope 204 is defined as the amount of information collected by the navigation system 100. For example, the collection scope 204 can represent the amount of the user's information 202 collected by the navigation system 100. For a specific example, the collection scope 204 can represent the frequency of collecting the user's information 202. More specifically, the collection scope 204 can be adjusted to collect the user's information 202 every 10 minutes or every 30 seconds. For another example, the collection scope 204 can represent the amount of data to be collected for the user's information 202. The collection scope 204 can be tailored to control the amount of the user's information 202 to be collected.

The collection scope 204 can be adjusted based on a monitoring factor 210. The monitoring factor 210 is defined as information considered by the navigation system 100 for setting the collection scope 204. For example, the monitoring factor 210 can include a social indicator 212, a geographic location 214, a time period 216, a user's profile 218, an activity pattern profile 220, a collection priority 222, a user type 224, or a combination thereof.

The social indicator 212 is defined as information related to a social relationship 226 within a social networking service (SNS). For example, SNS can include Facebook™, LinkedIn™, or Google+™. The social relationship 226 can represent a socio-spatial information or a social connection between the user and the another user within the SNS.

The social indicator 212 can include a degree of separation between the user and the another user within the SNS. For example, if the user is connected to the another user directly, the social indicator 212 can represent a first degree of separation. For another example, the social indicator 212 can include an expression of preference displayed within the SNS. For a specific example, the social indicator 212 can represent an icon or link available on the SNS for the user to select, write, or a combination thereof for displaying the user's positive or negative opinion towards the another user's expression.

The geographic location 214 can represent a physical location relevant to the user of the first device 102. For example, the geographic location 214 can include a current location to indicate the user's present physical location. For another example, the geographic location 214 can include a future location to indicate the user's physical location in the future. For a different example, the geographic location 214 can include a past location to indicate the physical location visited by the user.

The time period 216 can represent a variety of time of the day, week, month, year, or a combination thereof relevant to the user of the first device 102. For example, the time period 216 can include a current time or a future time.

The user's profile 218 can represent facts pertaining to the user of the first device 102. For example, the user's profile 218 can include race, sex, age, or a combination thereof of the user. For another example, the user's profile 218 can include the user's behavior 206. For a different example, the user's profile 218 can include a socio-economic information. The socio-economic information can include the user's home address, work address, capital stocks owned, or a combination thereof.

The activity pattern profile 220 can represent a compilation of recurring activity generated by the navigation system 100 regarding the user of the first device 102. For example, the activity pattern profile 220 can include places visited habitually by the user on Sundays for lunch. For another example, the activity pattern profile 220 can include the time the user leaves for work.

The collection priority 222 is defined as an order of importance placed on the monitoring factor 210. For example, the collection priority 222 can prioritize the social indicator 212 over the geographic location 214. For another example, the collection priority 222 can prioritize between a plurality of the time period 216. For a specific example, the collection priority 222 can prioritize the evenings over mornings.

The user type 224 can represent a categorization of the user of the first device 102. For example, the user can represent a socialite because the user frequents nightclubs and fine cuisine restaurants. The user type 224 can be categorized based on a type characteristic 232. The type characteristic 232 is defined as quality, feature, tendency, or a combination thereof of the user.

For example, the user type 224 can have the type characteristic 232. The adventurer can have the type characteristic 232 who deviates from the route generated by the navigation system 100. The traveler can have the type characteristic 232 who travels more than a predefined distance. For example, the predefined distance can represent 100 miles per week. The shopper can have the type characteristic 232 who has tendency to visit the geographic location 214 of a shopping district. The professional can have the type characteristic 232 who has tendency to visit the geographic location 214, for example, of a financial district.

The urban farmer can have the type characteristic 232 who tends to visit the geographic location 214, for example, of farmer's market or home improvement retail stores. The soccer mom can have the type characteristic 232 who tends to visit the geographic location 214, for example, of schools, playgrounds, and parks. The risk averse can have the type characteristic 232 who tends to avoid, for example, highways in the time period 216 of evenings. The eco-driver can have the type characteristic 232 who tends to drive, for example, less than 70 miles per hour on the highway. The socialite can have the type characteristic 232 who tends to visit nightclubs and fine cuisine restaurants.

The navigation system 100 can generate a notification 228 based on the user type 224 to tailor the notification 228 relevant to the user.

The notification 228 can represent a recommendation generated by the navigation system 100 to be displayed on the first device 102. For example, the notification 228 can include a personalized destination, an advertisement, navigation choices, or a combination thereof.

Another user's behavior 230 can represent acts performed by a user other than the user of the first device 102. For example, the another user's behavior 230 can include places searched for and driven by the another user, advertisement interaction by the another user, the another user's driving decisions, or a combination thereof.

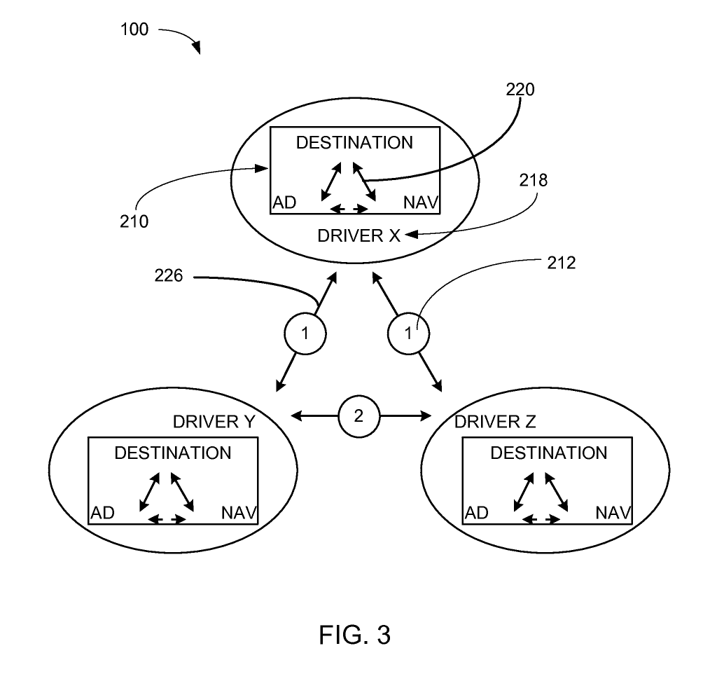

Referring now to FIG. 3, therein is shown an example of the monitoring factor 210. As discussed in FIG. 2, the monitoring factor 210 can include the social indicator 212, the social relationship 226, the user's profile 218, or a combination thereof for monitoring the user's behavior 206 of FIG. 2. The navigation system 100 can consider the monitoring factor 210 to adjust the collection scope 204 of FIG. 2 for collecting the user's information 202 of FIG. 2.

For example, the monitoring factor 210 can include the activity pattern profile 220. The activity pattern profile 220 can indicate the geographic location 214 of FIG. 2 visited by the user, the navigation information accepted by the user, the advertisement selected by the user, or a combination thereof. The activity pattern profile 220 can indicate the geographic location 214 frequented by the user. Further, the activity pattern profile 220 can indicate the user's behavior 206 for selecting the advertisement. Based on the activity pattern profile 220, the navigation system 100 can adjust the collection scope 204 to refine the ability of the navigation system 100 to collect the user's information 202. Based on the user's information 202 collected, the navigation system 100 can generate the notification 228 of FIG. 2 tailored to the user's interest. Details will be discussed below.

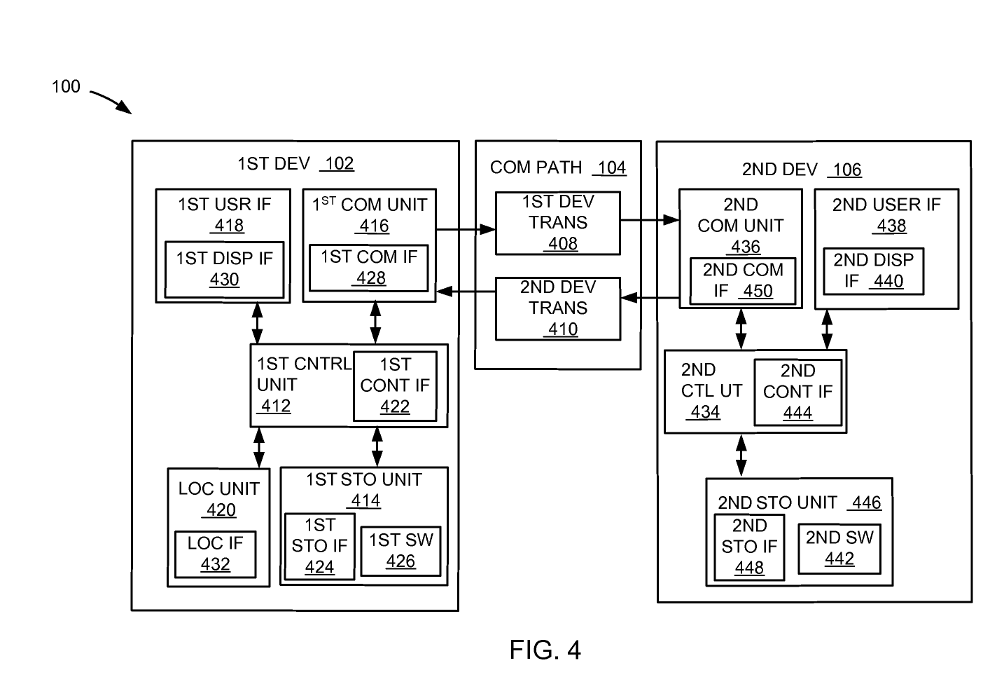

Referring now to FIG. 4, therein is shown an exemplary block diagram of the navigation system 100. The navigation system 100 can include the first device 102, the communication path 104, and the second device 106. The first device 102 can send information in a first device transmission 408 over the communication path 104 to the second device 106. The second device 106 can send information in a second device transmission 410 over the communication path 104 to the first device 102.

For illustrative purposes, the navigation system 100 is shown with the first device 102 as a client device, although it is understood that the navigation system 100 can have the first device 102 as a different type of device. For example, the first device 102 can be a server.

Also for illustrative purposes, the navigation system 100 is shown with the second device 106 as a server, although it is understood that the navigation system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 412, a first storage unit 414, a first communication unit 416, a first user interface 418, and a location unit 420. The first control unit 412 can include a first control interface 422. The first control unit 412 can execute a first software 426 to provide the intelligence of the navigation system 100. The first control unit 412 can be implemented in a number of different manners. For example, the first control unit 412 can be a processor, an embedded processor, a microprocessor, a hardware control logic, a hardware finite state machine (FSM), a digital signal processor (DSP), or a combination thereof. The first control interface 422 can be used for communication between the first control unit 412 and other functional units in the first device 102. The first control interface 422 can also be used for communication that is external to the first device 102.

The first control interface 422 can receive information from the other functional units or from external sources, or can transmit information to the other functional units or to external destinations. The external sources and the external destinations refer to sources and destinations physically separate from the first device 102.

The first control interface 422 can be implemented in different ways and can include different implementations depending on which functional units or external units are being interfaced with the first control interface 422. For example, the first control interface 422 can be implemented with a pressure sensor, an inertial sensor, a microelectromechanical system (MEMS), optical circuitry, waveguides, wireless circuitry, wireline circuitry, or a combination thereof.

The location unit 420 can generate location information, current heading, and current speed of the first device 102, as examples. The location unit 420 can be implemented in many ways. For example, the location unit 420 can function as at least a part of a global positioning system (GPS), an inertial navigation system, a cellular-tower location system, a pressure location system, or any combination thereof.

The location unit 420 can include a location interface 432. The location interface 432 can be used for communication between the location unit 420 and other functional units in the first device 102. The location interface 432 can also be used for communication that is external to the first device 102.

The location interface 432 can receive information from the other functional units or from external sources, or can transmit information to the other functional units or to external destinations. The external sources and the external destinations refer to sources and destinations physically separate from the first device 102.

The location interface 432 can include different implementations depending on which functional units or external units are being interfaced with the location unit 420. The location interface 432 can be implemented with technologies and techniques similar to the implementation of the first control interface 422.

The first storage unit 414 can store the first software 426. The first storage unit 414 can also store the relevant information, such as advertisements, points of interest (POI), navigation routing entries, or any combination thereof.

The first storage unit 414 can be a volatile memory, a nonvolatile memory, an internal memory, an external memory, or a combination thereof. For example, the first storage unit 414 can be a nonvolatile storage such as non-volatile random access memory (NVRAM), Flash memory, disk storage, or a volatile storage such as static random access memory (SRAM).

The first storage unit 414 can include a first storage interface 424. The first storage interface 424 can be used for communication between the location unit 420 and other functional units in the first device 102. The first storage interface 424 can also be used for communication that is external to the first device 102.

The first storage interface 424 can receive information from the other functional units or from external sources, or can transmit information to the other functional units or to external destinations. The external sources and the external destinations refer to sources and destinations physically separate from the first device 102.

The first storage interface 424 can include different implementations depending on which functional units or external units are being interfaced with the first storage unit 414. The first storage interface 424 can be implemented with technologies and techniques similar to the implementation of the first control interface 422.

The first communication unit 416 can enable external communication to and from the first device 102. For example, the first communication unit 416 can permit the first device 102 to communicate with the second device 106, an attachment, such as a peripheral device or a computer desktop, and the communication path 104.

The first communication unit 416 can also function as a communication hub allowing the first device 102 to function as part of the communication path 104 and not limited to be an end point or terminal unit to the communication path 104. The first communication unit 416 can include active and passive components, such as microelectronics or an antenna, for interaction with the communication path 104.

The first communication unit 416 can include a first communication interface 428. The first communication interface 428 can be used for communication between the first communication unit 416 and other functional units in the first device 102. The first communication interface 428 can receive information from the other functional units or can transmit information to the other functional units.

The first communication interface 428 can include different implementations depending on which functional units are being interfaced with the first communication unit 416. The first communication interface 428 can be implemented with technologies and techniques similar to the implementation of the first control interface 422.

The first user interface 418 allows a user (not shown) to interface and interact with the first device 102. The first user interface 418 can include an input device and an output device. Examples of the input device of the first user interface 418 can include a keypad, a touchpad, soft-keys, a keyboard, a microphone, or any combination thereof to provide data and communication inputs.

The first user interface 418 can include a first display interface 430. The first display interface 430 can include a display, a projector, a video screen, a speaker, or any combination thereof.

The first control unit 412 can operate the first user interface 418 to display information generated by the navigation system 100. The first control unit 412 can also execute the first software 426 for the other functions of the navigation system 100, including receiving location information from the location unit 420. The first control unit 412 can further execute the first software 426 for interaction with the communication path 104 via the first communication unit 416.

The second device 106 can be optimized for implementing the present invention in a multiple device embodiment with the first device 102. The second device 106 can provide the additional or higher performance processing power compared to the first device 102. The second device 106 can include a second control unit 434, a second communication unit 436, and a second user interface 438.

The second user interface 438 allows a user (not shown) to interface and interact with the second device 106. The second user interface 438 can include an input device and an output device. Examples of the input device of the second user interface 438 can include a keypad, a touchpad, soft-keys, a keyboard, a microphone, or any combination thereof to provide data and communication inputs. Examples of the output device of the second user interface 438 can include a second display interface 440. The second display interface 440 can include a display, a projector, a video screen, a speaker, or any combination thereof.

The second control unit 434 can execute a second software 442 to provide the intelligence of the second device 106 of the navigation system 100. The second software 442 can operate in conjunction with the first software 426. The second control unit 434 can provide additional performance compared to the first control unit 412.

The second control unit 434 can operate the second user interface 438 to display information. The second control unit 434 can also execute the second software 442 for the other functions of the navigation system 100, including operating the second communication unit 436 to communicate with the first device 102 over the communication path 104.

The second control unit 434 can be implemented in a number of different manners. For example, the second control unit 434 can be a processor, an embedded processor, a microprocessor, a hardware control logic, a hardware finite state machine (FSM), a digital signal processor (DSP), or a combination thereof.

The second control unit 434 can include a second control interface 444. The second control interface 444 can be used for communication between the second control unit 434 and other functional units in the second device 106. The second control interface 444 can also be used for communication that is external to the second device 106.

The second control interface 444 can receive information from the other functional units or from external sources, or can transmit information to the other functional units or to external destinations. The external sources and the external destinations refer to sources and destinations physically separate from the second device 106.

The second control interface 444 can be implemented in different ways and can include different implementations depending on which functional units or external units are being interfaced with the second control interface 444. For example, the second control interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the relevant information, such as advertisements, points of interest (POI), navigation routing entries, or any combination thereof. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the navigation system 100 is shown with the second storage unit 446 as a single hierarchy storage system, although it is understood that the navigation system 100 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between the location unit 420 and other functional units in the second device 106. The second storage interface 448 can also be used for communication that is external to the second device 106.

The second storage interface 448 can receive information from the other functional units or from external sources, or can transmit information to the other functional units or to external destinations. The external sources and the external destinations refer to sources and destinations physically separate from the second device 106.

The second storage interface 448 can include different implementations depending on which functional units or external units are being interfaced with the second storage unit 446. The second storage interface 448 can be implemented with technologies and techniques similar to the implementation of the second control interface 444.

The second communication unit 436 can enable external communication to and from the second device 106. For example, the second communication unit 436 can permit the second device 106 to communicate with the first device 102 over the communication path 104.

The second communication unit 436 can also function as a communication hub allowing the second device 106 to function as part of the communication path 104 and not limited to be an end point or terminal unit to the communication path 104. The second communication unit 436 can include active and passive components, such as microelectronics or an antenna, for interaction with the communication path 104.

The second communication unit 436 can include a second communication interface 450. The second communication interface 450 can be used for communication between the second communication unit 436 and other functional units in the second device 106. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second control interface 444.

The first communication unit 416 can couple with the communication path 104 to send information to the second device 106 in the first device transmission 408. The second device 106 can receive information in the second communication unit 436 from the first device transmission 408 of the communication path 104.

The second communication unit 436 can couple with the communication path 104 to send information to the first device 102 in the second device transmission 410. The first device 102 can receive information in the first communication unit 416 from the second device transmission 410 of the communication path 104. The navigation system 100 can be executed by the first control unit 412, the second control unit 434, or a combination thereof.

For illustrative purposes, the second device 106 is shown with the partition having the second user interface 438, the second storage unit 446, the second control unit 434, and the second communication unit 436, although it is understood that the second device 106 can have a different partition. For example, the second software 442 can be partitioned differently such that some or all of its function can be in the second control unit 434 and the second communication unit 436. Also, the second device 106 can include other functional units not shown in FIG. 4 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the navigation system 100 is described by operation of the first device 102 and the second device 106. It is understood that the first device 102 and the second device 106 can operate any of the modules and functions of the navigation system 100. For example, the first device 102 is described to operate the location unit 420, although it is understood that the second device 106 can also operate the location unit 420.

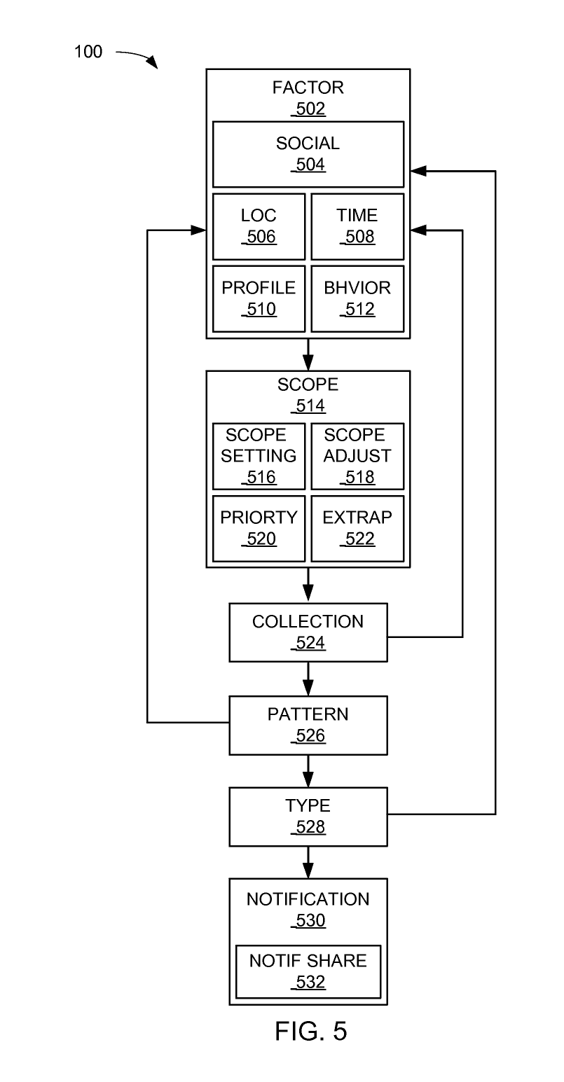

Referring now to FIG. 5, therein is shown a control flow of the navigation system 100. The navigation system 100 can include a factor module 502. The factor module 502 identifies the monitoring factor 210 of FIG. 2. For example, the factor module 502 can identify the monitoring factor 210 in a number of ways.

The factor module 502 can include a social module 504. The social module 504 identifies the monitoring factor 210 based on determining the social indicator 212 of FIG. 2. For example, the social module 504 can determine the social indicator 212 for identifying the social relationship 226 of FIG. 2. The social module 504 can determine the social indicator 212 in a number of ways.

For example, the social module 504 can determine the social indicator 212 by identifying the social relationship 226 between the user and the another user within the SNS. More specifically, the social indicator 212 can access the SNS via the first control interface 422 of FIG. 4 to determine the type of the social relationship 226 that the user can have with the another user within the SNS by logging into the SNS. For a specific example, the social relationship 226 established by the user can be mainly from the university attended by the user. The social indicator 212 can represent that the first degree of connection established by the user can represent mainly with the classmates from the university. The social module 504 can determine the social indicator 212 between the user and the another user who is a classmate to be separated by first degree of separation.

For another example, the social module 504 can determine the social indicator 212 by identifying the expression of preference displayed by the user within the SNS. For a specific example, the user can select the advertisement for a sale for shoes displayed within the SNS. By selecting the advertisement, the social module 504 can determine that the social indicator 212 of the user's interest in the category of interest 208 of FIG. 2 to be shopping.

The factor module 502 can include a location module 506. The location module 506 identifies the monitoring factor 210 based on determining the geographic location 214 of FIG. 2. For example, the location module 506 can determine the geographic location 214 representative of the user's future location. The location module 506 can determine the geographic location 214 in a number of ways.

The location module 506 can determine the geographic location 214 of the current location via the location unit 420 of FIG. 4. For another example, the location module 506 can determine the geographic location 214 of the future location by identifying the address information recorded in a calendar schedule within the first device 102 of FIG. 1 for future dates. For a different example, the location module 506 can determine the geographic location 214 of past location by identifying the places the user had visited. The location module 506 can log the past location visited by the user with the first device 102.

The factor module 502 can include a time module 508. For example, the time module 508 identifies the monitoring factor 210 based on determining the time period 216 of FIG. 2. For a specific example, the time module 508 can determine the time period 216 representative of today's date displayed on the first device 102.

The factor module 502 can include a profile module 510. For example, the profile module 510 identifies the monitoring factor 210 based on determining the user's profile 218 of FIG. 2. For a specific example, the profile module 510 can determine the user's profile 218 based on the information entered by the user. More specifically, the user's profile 218 can have the geographic location 214, such as home address, work address, or a combination thereof, preset by the user in the profile module 510.

For a different example, the profile module 510 can generate the user's profile 218 based on obtaining the socio-economic information from external sources via the first control interface 422. More specifically, the profile module 510 can obtain the socio-economic information, such as amount of capital stocks owned, the value of user's real estate property, or a combination thereof, from external sources, such as Yahoo! Finance™, Zillow™, or a combination thereof. Details regarding the updating of the user's profile 218 will be discussed below.

The factor module 502 can include a behavior module 512. For example, the behavior module 512 identifies the monitoring factor 210 based on determining the user's behavior 206 of FIG. 2. For a specific example, the behavior module 512 can determine the user's behavior 206 based on the user's information 202 collected. Details regarding the determination of the user's behavior 206 will be discussed below.

The navigation system 100 can include a scope module 514, which can be coupled to the factor module 502. The scope module 514 determines the collection scope 204 of FIG. 2. For a specific example, the scope module 514 can determine the collection scope 204 by setting the collection scope 204 based on the monitoring factor 210.

The scope module 514 can set the collection scope 204 in a number of ways. The scope module 514 can include a scope setting module 516. The scope setting module 516 sets the collection scope 204. For example, the scope setting module 516 can set the collection scope 204 when the navigation system 100 was initially invoked. For a specific example, the scope setting module 516 can set the collection scope 204 based on the monitoring factor 210, such as the user's information 202 of FIG. 2 related to the social indicator 212, the geographic location 214, the time period 216, the user's profile 218, the user's behavior 206, the user type 224 of FIG. 2, or a combination thereof. More specifically, the scope setting module 516 can set the collection scope 204 based on the geographic location 214 of San Jose, Calif. between the time period 216 of 9 PM to 12 AM.

For another example, the scope setting module 516 can set the collection scope 204 based on the user's profile 218 entered initially into the first device 102 by the user. If the user's profile 218 is a female adult, the scope setting module 516 can set the collection scope 204 for collecting the user's information 202 related to activities during the time period 216 of evenings. The collection scope 204 can be set for collecting the user's information 202 in the evenings to monitor the user's nighttime activities for safety concerns, as females can be more vulnerable in terms of safety at night. In contrast, if the user's profile 218 is representative of a male adult, the collection scope 204 can be set for the time period 216 during the commute hours of 5 AM to 9 AM to track the user's driving pattern, as safety concern might be less for the male adult at night.

For a different example, the scope setting module 516 can set the collection scope 204 based on the social indicator 212 for collecting information related to the another user's behavior 230 of FIG. 2. More specifically, the scope setting module 516 can set the collection scope 204 based on the social indicator 212 of first degree of separation within the SNS. As a result, the collection scope 204 can be set for the navigation system 100 to collect the another user's behavior 230 with the social relationship 226 of first degree of separation from the user.

The scope module 514 can include a scope adjuster module 518, a priority module 520, and an extrapolation module 522. Details regarding each module will be discussed below.

The navigation system 100 can include a collection module 524, which can be coupled to the scope module 514. The collection module 524 collects the user's information 202. For example, the collection module 524 can collect the user's information 202 based on the collection scope 204.

The collection module 524 can collect the user's information 202 in a number of ways. For example, the collection scope 204 can be set for the collection module 524 to collect the user's information 202 for the social relationship 226 established within the SNS. More specifically, the collection module 524 can collect who the user is connected to within the SNS based on the collection scope 204 by looking at the social indicator 212, such as friends, occupations, and education information.

For a different example, the collection scope 204 can be set for the collection module 524 to collect the user's information 202 related to the social indicator 212 within the SNS. For a specific example, the collection module 524 can collect the user's information 202 pertaining to the social indicator 212 expressed by the user within the SNS based on the collection scope 204. More specifically, the collection module 524 can collect the social indicator 212, such as the social relationship 226 established or broken by the user within SNS.

For another example, the collection module 524 can collect limited amount of data related to the user's information 202 if the collection scope 204 limits the what kind of information to be collected. For a specific example, the collection module 524 can collect the user's information 202 pertaining to the user's behavior 206 if the collection scope 204 is set to collect the user's behavior 206 only.

For a different example, the collection scope 204 can be set to collect the user's information 202 related to the user's behavior 206. As a result, the collection module 524 can collect the user's information 202 related to the user's behavior 206, such as the places searched for and driven by the user of the first device 102, the advertisement interaction by the user, the user's driving decisions, or a combination thereof.

More specifically, the collection module 524 can collect the user's information 202 pertaining to the geographic location 214 selected by the user of the first device 102, driven to by the user of the first device 102, or a combination thereof. For further example, the collection module 524 can collect the user's information 202 related to the route selected by the user of the first device 102, the speed of the vehicle driven by the user of the first device 102, or a combination thereof. Additionally, the collection module 524 can collect the user's information 202 related to the time period 216 driven by the user of the first device 102, a traffic condition where driven, or a combination thereof. For a different example, the collection module 524 can collect the advertisement selected, driven to, or a combination thereof by the user of the first device 102.

For another example, as discussed previously, the collection module 524 can collect the information related to the another user's behavior 230 based on the collection scope 204. The collection module 524 can collect the information related to the another user's behavior 230 similarly to the collection of the user's information 202.

The navigation system 100 can include a pattern module 526, which can be coupled to the collection module 524. The pattern module 526 generates the activity pattern profile 220 of FIG. 2. For example, the pattern module 526 can generate the activity pattern profile 220 based on the user's information 202 collected.

The pattern module 526 can generate the activity pattern profile 220 in a number of ways. For example, the pattern module 526 can generate the activity pattern profile 220 for a spatial usage pattern, an advertisement usage pattern, a driving usage pattern, or a combination thereof. The spatial usage pattern can represent the tendency of the user of the first device 102 to visit the geographic location 214, to select the geographic location 214, or a combination thereof. The advertisement usage pattern can represent the tendency of the user of the first device 102 to select or drive to the notification 228 of FIG. 2 selected. The driving usage pattern can represent the tendency by the user of the first device 102 to take a longer route, deviate from the route suggested by the navigation system 100, drive above the speed limit, or a combination thereof.

For a specific example, the user's information 202 collected can indicate that the user of the first device 102 can have the tendency to visit an indoor soccer facility on Tuesday nights to play in a soccer league. The pattern module 526 can generate the activity pattern profile 220 based on the user's information 202 to include the spatial usage pattern of visiting the indoor soccer facility.

For another example, the pattern module 526 can generate the activity pattern profile 220 based on the user's information 202 pertaining to the user's behavior 206, the geographic location 214, the time period 216, or a combination thereof. For a specific example, the user's behavior 206 can show that the user of the first device 102 tends to select the notification 228 related to the category of interest 208 of restaurants after the time period 216 of 5 PM on Fridays when he is at the geographic location 214 of his office. The pattern module 526 can generate the activity pattern profile 220 for the user of the first device 102 to include the user's behavior 206 of selecting the notification 228, the category of interest 208 preferred by the user, the time period 216 and the geographic location 214 of the user's behavior 206, or a combination thereof. More specifically, the pattern module 526 can generate the activity pattern profile 220 that includes the spatial usage pattern, the advertisement usage pattern, the driving usage pattern, or a combination thereof.

For another example, the pattern module 526 can generate the activity pattern profile 220 based on the user's information 202 pertaining to the social indicator 212. For a specific example, the social indicator 212 can show that the user expressed her positive opinion towards to a digital photograph posted on the SNS by the another user within the SNS. The positive opinion can be expressed by clicking the “like” link for Facebook™, the “+1” link for Google+™, or writing sentences that includes words, such as “good” or “great.” The pattern module 526 can generate the activity pattern profile 220 that includes the user's behavior 206 within the SNS by including the social indicator 212 of to whom within the SNS had user posted the positive opinion.

The navigation system 100 can include a type module 528. The type module 528 generates the user type 224. For example, the type module 528 can generate the user type 224 based on the activity pattern profile 220, the type characteristic 232 of FIG. 2, or a combination thereof.

The type module 528 can generate the user type 224 in a number of ways. For example, the type module 528 can categorize the user type 224 based on the type characteristic 232. The user type 224 can include adventurer, traveler, shopper, professional, urban farmer, soccer mom, risk averse, eco-driver, or socialite as discussed in FIG. 2.

For example, the activity pattern profile 220 can include the user's profile 218 as female adult, the user's behavior 206 of not driving during the evenings, or a combination thereof. By comparing the activity pattern profile 220 to the type characteristic 232 of the user type 224, the type module 528 can generate the user type 224 of the user of the first device 102 to be risk averse.

For another example, the type module 528 can generate the user type 224 for the user of the first device 102 based on the user's behavior 206, the time period 216, the geographic location 214, or a combination thereof. More specifically, the user's behavior 206 can indicate that the user can be in the geographic location 214 of the financial district between the time period 216 of 9 AM to 7 PM. By analyzing type characteristic 232 of the user type 224 and comparing the type characteristic 232 to the user's behavior 206, the geographic location 214, and the time period 216, the type module 528 can generate the user type 224 of the user to be a professional.

In contrast, the user's behavior 206 for the same instance of the user of the first device 102, who is the professional, can change for the time period 216 of Saturday. More specifically, the user's behavior 206 can indicate that user tends to be in the geographic location 214 of the shopping district on Saturdays. By reevaluating the type characteristic 232 for each of the user type 224 by comparing to the user's behavior 206, the type module 528 can update the user type 224 to be shopper for the user for the time period 216 of Saturdays.

The navigation system 100 can include a notification module 530, which can be coupled to the type module 528. The notification module 530 generates the notification 228. For example, the notification module 530 can generate the notification 228 based on the user's information 202 collected, the activity pattern profile 220, or a combination thereof.

The notification module 530 can generate the notification 228 in a number of ways. For example, the notification module 530 can generate the notification 228 based on the activity pattern profile 220. The activity pattern profile 220 can indicate the user's tendency to go to happy hour on Friday nights. The notification module 530 can generate the notification 228 for the information pertaining to happy hour advertisement for the time period 216 of Friday nights.

For another example, the notification module 530 can generate the notification 228 based on the user type 224. The user type 224 can be soccer mom. The notification module 530 can generate the notification 228 that suggests the geographic location 214 for where the kids can play soccer. More specifically, the notification module 530 can customize the notification 228 based on the user type 224 by including the information interested by the user with the particular instance of the user type 224. For example, the notification module 530 can customize the notification 228 by generating the notification 228 to include a bargain sale for the user type 224 of shopper.

For another example, the notification module 530 can customize the notification 228 based on the activity pattern profile 220 for displaying on the first device 102. More specifically, the activity pattern profile 220 can indicate the user's behavior 206 of preferring a route with the least traffic. The notification module 530 can customize the notification 228 by generating the notification 228 to include a route with the least traffic congestion even though the physical distance that the user will travel may be longer.

The notification module 530 can include a notification share module 532. The notification share module 532 shares the notification 228. For example, the notification share module 532 can share the notification 228 based on the social indicator 212.

The notification share module 532 can share the notification 228 in a number of ways. For example, the notification share module 532 can share the notification 228 based on the social indicator 212 representative of user's expression within the SNS. If the user expressed an opinion within the SNS related to a product he purchased, the notification share module 532 can share the notification 228 related to the product to the other user's within the SNS. More specifically, the notification share module 532 can limit the sharing of the notification 228 based on the social relationship 226 of first degree of separation from the user.

For another example, the notification share module 532 can share the notification 228 based on the user's behavior 206, the another user's behavior 230, the social indicator 212, or a combination thereof. The user's behavior 206 can indicate that the user had found a new shortcut to reach the geographic location 214. The another user's behavior 230 can indicate that the another user also travels to the same location for the geographic location 214. The user and the another user can have the social indicator 212 with the social relationship 226 of first degree of separation. The notification share module 532 can send the notification 228 of a new shortcut based on the user's behavior 206 or the another user's behavior 230 so long as the social relationship 226 remains first degree of separation. More specifically, if the user finds the shortcut, the notification share module 532 can share the notification 228 to the another user. If the another user finds the shortcut, the notification share module 532 can share the notification 228 to the user.

For illustrative purposes, the navigation system 100 is shown with the profile module 510 generating the user's profile 218, although it is understood that the profile module 510 can be operated differently. For example, the profile module 510 can update the user's profile 218.

The profile module 510 can update the user's profile 218 in a number of ways. For example, the profile module 510 can update the user's profile 218 to include the activity pattern profile 220. Initially, the activity pattern profile 220 can indicate that the user of the first device 102 lived in Nevada where no wineries close by. Subsequently, the activity pattern profile 220 can show that the user visits the geographic location 214 of wineries frequently after moving to California. The profile module 510 can update the user's profile 218 to include the user's tendency to visit wineries.

For another example, the profile module 510 can update the user's profile 218 based on the user type 224. Initially, the user's profile 218 may not include the user type 224. However, as the activity pattern profile 220 is built and the user type 224 is generated, the user's profile 218 can be updated by the profile module 510 to include the user type 224. More specifically, if the activity pattern profile 220 indicates that the user visits hiking trails frequently, the profile module 510 can update the user's profile 218 to include the user type 224 of adventurer.

For illustrative purposes, the navigation system 100 is shown with the behavior module 512 determining the user's behavior 206, although it is understood that the behavior module 512 can be operated differently. For example, the behavior module 512 can determine the user's behavior 206 based on the user's information 202 collected.

The behavior module 512 can determine the user's behavior 206 in a number of ways. For example, the user's information 202 collected can indicate that the user of the first device 102 prefers to go to Peet's Coffee™ over Starbucks Coffee™ based on the frequency of the geographic location 214 visited by the user. The behavior module 512 can determine the user's behavior 206 to be that user is a coffee drinker and has particular preference for drinking coffee. For another example, the user's information 202 collected can indicate that user of the first device 102 can update user's SNS page with places visited around the world. The behavior module 512 can determine the user's behavior 206 to be that user is an avid traveler.

For illustrative purposes, the navigation system 100 is shown with the scope module 514 setting the collection scope 204, although it is understood that the scope module 514 can be operated differently. For example, the scope module 514 can adjust the collection scope 204 based on the social indicator 212 for monitoring the user's behavior 206. For another example, the scope module 514 can set the collection priority 222 of FIG. 2. For a different example, the scope module 514 can extrapolate the collection scope 204 based on the monitoring factor 210 for adjusting the collection scope 204.

The scope module 514 can include the priority module 520. The priority module 520 sets the collection priority 222. For example, the priority module 520 can set the collection priority 222 based on the activity profile 220.

The priority module 520 can set the collection priority 222 in a number of ways. For example, the activity pattern profile 220 can indicate the user's tendency to visit the geographic location 214 of a football stadium during the time period 216 of Fall and Winter. The user's behavior 206 during the time period 216 can also indicate the driving pattern of visiting the geographic location 214 of grocery store to pick up supplies for tail gating. In contrast, the user's behavior 206 for visiting the wineries can decrease during the time period 216 of Fall and Winter. The priority module 520 can put a higher priority for collecting the user's information 202 related to the user's behavior 206 for driving to the geographic location 214 of football stadium and grocery store than and driving to the geographic location 214 of wineries based on the frequency of visits to the geographic location 214. More specifically, the priority module 520 can generate the collection priority 222 that is higher for collecting the user's information 202 related to the geographic location 214 of football stadiums and grocery stores than the geographic location 214 of wineries during the time period 216 of Fall and Summer

For another example, the priority module 520 can set the collection priority 222 by ranking the user's information 202 to be collected. More specifically, the ranking of the user's information 202 to be collected can represent the order of importance for the user's information 202 to be collected. The ranking can base on the monitoring factor 210, such as the activity pattern profile 220, the user type 224, or a combination thereof.

For example, as discussed previously, the activity pattern profile 220 can indicate that user visits the geographic location 214 of the indoor soccer facility on Tuesday nights. The priority module 520 can rank the collection of the user's information 202 related to the user's behavior 206 for traveling to the indoor soccer facility to be higher than other instances of the user's information 202 for the time period 216 of Tuesdays because of the frequency of visits. For another example, the user type 224 can represent shopper. As a result, the priority module 520 can place a higher priority for collecting the user's information 202 for the user's behavior 206 related to shopping than visits to national parks.

The scope module 514 can include the scope adjuster module 518. The scope adjuster module 518 adjusts the collection scope 204. For example, the scope adjuster module 518 can adjust the collection scope 204 based on the monitoring factor 210.

The scope adjuster module 518 can adjust the collection scope 204 in a number of ways. For example, the scope module 514 can adjust the collection scope 204 based on the monitoring factor 210, such as the geographic location 214, the time period 216, or a combination thereof. The geographic location 214 can represent a physical location within a high crime area. The time period 216 can represent night. The scope adjuster module 518 can adjust the collection scope 204 by increasing the collection scope 204 for the user's behavior 206 for the high crime area at night.

More specifically, the collection scope 204 for the user's behavior 206 for driving to the geographic location 214 can be increased to track the user's activity pattern within the high crime area. Originally, the collection scope 204 can be set to collect the user's behavior 206 every 10 minutes. By increasing the collection scope 204, the user's behavior 206 can be collected every 30 seconds.

For another example, the collection scope 204 can be updated based on increasing or decreasing the amount of the user's information 202 collected. For a specific example, the collection scope 204 can be decreased by reducing the amount of data collected when the user of the first device 102 leaves the geographic location 214 of the high crime area. More specifically, the collection scope 204 can be reduced from collecting the user's information 202 related to every turn made by the vehicle driven by the user to each major streets crossed by the user's vehicle.

For a different example, the collection scope 204 can be adjusted by increasing one instance of the user's information 202 to be collected while decreasing another instance of the user's information 202 to be collected. For a specific example, while the collection scope 204 for the user's information 202 related to the user's behavior 206 can be increased, the collection scope 204 for the user's information 202 related to the social indicator 212 can be decreased to collect less information related to the social indicator 212. The scope adjuster module 518 can increase the collection scope 204 for collecting the user's information 202 related to the user's behavior 206 based on the geographic location 214 of a high crime area to track the user's activity for safety reasons. In contrast, the collection scope 204 for the user's information 202 related to the social indicator 212 can be decreased as the collection priority 222 for collecting the user's information 202 related to the social indicator 212 can be lower while driving through a high crime area. Further, the scope adjuster module 518 can update the collection scope 204 by increasing or decreasing the collection scope 204 as the user of the first device 102 travels along the route to change the geographic location 214.

It has been discovered that the navigation system 100 can adjust the collection scope 204 to improve the efficiency of the collection of the user's information 202. By adjusting the collection scope 204, the navigation system 100 can customize the collection of the user's information 202 with finer control. As a result, the resource allocated to collect the user's information 202 can be efficiently maximized for the safer operation of the navigation system 100 and the vehicle.

The scope adjuster module 518 can adjust the collection scope 204 based on the social indicator 212. The social indicator 212 can show that the user of the first device 102 can have the social relationship 226 with mainly nonprofit organization volunteers. The nonprofit organization volunteers can represent people with peaceful temperament. The user type 224 can represent eco-driver. The scope adjuster module 518 can decrease the collection scope 204 for collecting the user's behavior for driving activity to every 30 minutes based on the social indicator 212, the user's behavior 206, or a combination thereof to reflect the lack of necessity to track the user's driving activity for safety reasons.

It has been discovered that the navigation system 100 can adjust the collection scope 204 based on the social indicator 212 to improve the efficiency of collecting the user's information 202. By considering the social indicator 212, the navigation system 100 can determine what is most relevant to the user of the first device 102 for collecting the user's information 202. Subsequently, the navigation system 100 can adjust the collection scope 204 to improve the accuracy for what information of the user's information 202 should be collected. As a result, the navigation system 100 can generate the notification 228 most relevant to the user for the safer operation of the navigation system 100 and the vehicle.

The scope adjuster module 518 can adjust the collection scope 204 based on the user's profile 218. For example, the user's profile 218 can indicate the user of the first device 102 can be a teenager. The scope adjuster module 518 can increase the collection scope 204 for collecting the user's information for the user's behavior 206 for driving and the geographic location 214 visited to track the user's activity for safety reasons. In contrast, if the user's profile 218 can indicate the user of the first device 102 to be a fifty year old male adult, the scope adjuster module 518 can decrease the collection scope 204 to collect less of the user's information 202 to minimize resources used by the navigation system 100. Further, the scope adjuster module 518 can update the collection scope 204 as the user's profile 218 changes with age by increasing or decreasing the collection scope 204. Additionally, the scope adjuster module 518 can update the collection scope 204 as the activity pattern profile 220 changes with change in the user's behavior 206 for adjusting the collection scope 204.

The scope adjuster module 518 can adjust the collection scope 204 based on the collection priority 222. The collection priority 222 can set a higher priority for the user's information 202 related to the social indicator 212 over the user type 224. As a result, the scope adjuster module 518 can increase the collection scope 204 for collecting the user's information 202 related to the social indicator 212 while decreasing the collection scope 204 for collecting the user's information 202 based on the user type 224.

The scope adjuster module 518 can adjust the collection scope 204 based on the another user's behavior 230. The another user's behavior 230 can indicate he is driving through the geographic location 214 with forest fire. The user of the first device 102 can be driving towards the geographic location 214 where the another user is currently driving. The scope adjuster module 528 can increase the collection scope 204 by increasing the amount of information to be collected based on the another user's behavior 230. More specifically, the collection scope 204 can be increased by adding the tracking of the air quality for areas surrounding the geographic location 214 for safety precaution.

It has been discovered that the navigation system 100 can adjust the collection scope 204 based on the another user's behavior 230 to improve the efficiency of collecting the user's information 202. By considering the another user's behavior 230, the navigation system 100 can determine what is most relevant to the user of the first device 102 for collecting the user's information 202. Subsequently, the navigation system 100 can adjust the collection scope 204 to improve the accuracy for what information of the user's information 202 should be collected. As a result, the navigation system 100 can generate the notification 228 most relevant to the user for the safer operation of the navigation system 100 and the vehicle.

The scope module 514 can include the extrapolation module 522. The extrapolation module 522 extrapolates the collection scope 204. For example, the extrapolation module 522 can extrapolate the collection scope 204 based on the monitoring factor 210 for adjusting the collection scope 204.

The extrapolation module 522 can extrapolate the collection scope 204 in a number of ways. For example, the extrapolation module 522 can extrapolate the collection scope 204 based on the user's behavior 206. The user's behavior 206 can indicate the user's aggressive nature for driving the vehicle on the highway. The extrapolation module 522 can extrapolate the collection scope 204 to be higher if the user is driving on the highway than if the user is driving on local streets to collect more of the user's information 202 related to the user's behavior 206 on the highway.

For a different example, the extrapolation module 522 can extrapolate the collection scope 204 based on the social indicator 212. The extrapolation module 522 can extrapolate the collection scope 204 to be lower for the social indicator 212 representative of greater than second degree of separation than the social indicator 212 representative of the first degree of separation. More specifically, the social indicator 212 that is further apart in degrees of separation can be less important to the user than the social relationship 226 within the first degree of separation. As a result, the extrapolation module 522 can extrapolate the collection scope 204 to be lower for the social indicator 212 that is further apart in degrees of separation to collect less information for the user's information 202.

It has been discovered that the navigation system 100 can extrapolate the collection scope 204 to improve the efficiency of collecting the user's information 202. By extrapolating the collection scope 204, the navigation system 100 can determine what is most relevant to the user of the first device 102 for collecting the user's information 202. Subsequently, the navigation system 100 can adjust the collection scope 204 to improve the accuracy for what information of the user's information 202 should be collected. As a result, the navigation system 100 can generate the notification 228 most relevant to the user for the safer operation of the navigation system 100 and the vehicle.

The physical transformation from traveling from one instance of the geographic location 214 to another instance of the geographic location 214 results in movement in the physical world, such as people using the first device 102, the vehicle, or a combination thereof, based on the operation of the navigation system 100. As the movement in the physical world occurs, the movement itself creates additional information that is converted back into the activity pattern profile 220 for adjusting the collection scope 204 for the continued operation of the navigation system 100 and to continue the movement in the physical world.

The first software 426 of FIG. 4 of the first device 102 of FIG. 4 can include the modules for the navigation system 100. For example, the first software 426 can include the factor module 502, the scope module 514, the collection module 524, the pattern module 526, the type module 528, and the notification module 530.

The first control unit 412 of FIG. 4 can execute the first software 426 for the factor module 502 to determine the monitoring factor 210. The first control unit 412 can execute the first software 426 for the scope module 514 to set the collection scope 204. The first control unit 412 can execute the first software 426 for the collection module 524 to collect the user's information 202. The first control unit 412 can execute the first software 426 for the pattern module 526 to generate the activity pattern profile 220. The first control unit 412 can execute the first software 426 for the type module 528 to generate the user type 224. The first control unit 412 can execute the first software 426 for the notification module 530 to generate the notification 228.

The second software 442 of FIG. 4 of the second device 106 of FIG. 4 can include the modules for the navigation system 100. For example, the second software 442 can include the factor module 502, the scope module 514, the collection module 524, the pattern module 526, the type module 528, and the notification module 530.

The second control unit 434 of FIG. 4 can execute the second software 442 for the factor module 502 to determine the monitoring factor 210. The second control unit 434 can execute the second software 442 for the scope module 514 to set the collection scope 204. The second control unit 434 can execute the second software 442 for the collection module 524 to collect the user's information 202. The second control unit 434 can execute the second software 442 for the pattern module 526 to generate the activity pattern profile 220. The second control unit 434 can execute the second software 442 for the type module 528 to generate the user type 224. The second control unit 434 can execute the second software 442 for the notification module 530 to generate the notification 228.

The modules of the navigation system 100 can be partitioned between the first software 426 and the second software 442. For example, the second software 442 can include the factor module 502, the scope module 514, the pattern module 526, the type module 528, and the notification module 530. The second control unit 434 can execute modules partitioned on the second software 442 as previously described.

The first software 426 can include the collection module 524. Based on the size of the first storage unit 414 of FIG. 4, the first software 426 can include additional modules of the navigation system 100. The first control unit 412 can execute the modules partitioned on the first software 426 as previously described.

The first control unit 412 can operate the first communication unit 416 of FIG. 4 to send the user's information 202 to the second device 106. The first control unit 412 can operate the first software 426 to operate the location unit 420 of FIG. 4. The second communication unit 436 of FIG. 4 can send the notification 228 to the first device 102 through the communication path 104 of FIG. 4.

The navigation system 100 describes the module functions or order as an example. The modules can be partitioned differently. For example, the pattern module 526 and the type module 528 can be combined. Each of the modules can operate individually and independently of the other modules.

It has been discovered that the navigation system 100 can collect the user's information 202 to generate the notification 228 most relevant to the user of the first device 102. By adjusting the collection scope 204, the navigation system 100 can control the user's information 202 to be collected. As a result, the navigation system 100 can efficiently maximize the resource required to collect the user's information 202 for the safer operation of the navigation system 100 and the vehicle.

Furthermore, data generated in one module can be used by another module without being directly coupled to each other. For example, the type module 528 can receive the user's information 202 from the collection module 524 directly. The factor module 502, the scope module 514, the collection module 524, the pattern module 526, the type module 528, and the notification module 530 can be implement in as hardware (not shown) within the first control unit 412, the second control unit 434, or special hardware (not shown) in the first device 102 or the second device 106.

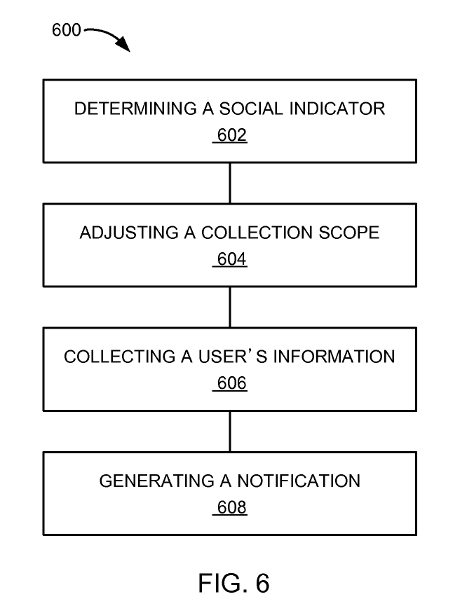

Referring now to FIG. 6, therein is shown a flow chart of a method 600 of operation of the navigation system 100 of FIG. 1 in a further embodiment of the present invention. The method 600 includes: determining a social indicator for identifying a social relationship in a block 602; adjusting a collection scope based on the social indicator for monitoring a user's behavior in a block 604; collecting a user's information based on the collection scope in a block 606; and generating a notification based on the user's information for displaying on a device in a block 608.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a navigation system comprising:
determining a social indicator for identifying a social relationship;
adjusting a collection scope based on the social indicator for monitoring a user's behavior;
collecting a user's information based on the collection scope; and
generating a notification based on the user's information for displaying on a device.

2. The method as claimed in claim 1 further comprising:
generating a user type based on an activity pattern profile; and
wherein:
generating the notification includes customizing the notification based on the user type for displaying on the device.

3. The method as claimed in claim 1 further comprising extrapolating the collection scope based on a monitoring factor for adjusting the collection scope.

4. The method as claimed in claim 1 further comprising:
generating an activity pattern profile based on the user's information; and
wherein:
generating the notification includes customizing the notification based on the activity pattern profile for displaying on the device.

5. The method as claimed in claim 1 further comprising:
setting a collection priority for adjusting the collection scope; and
wherein:
collecting the user's information based on the collection priority for generating the notification.

6. A method of operation of a navigation system comprising:
determining a social indicator for identifying a social relationship;
adjusting a collection scope based on the social indicator for monitoring a user's behavior;
collecting a user's information based on the collection scope;
generating an activity pattern profile based on the user's information; and
generating a notification based on the activity pattern profile for displaying on a device.

7. The method as claimed in claim 6 wherein adjusting the collection scope includes adjusting the collection scope based on an another user's behavior for collecting the user's information.

8. The method as claimed in claim 6 further comprising updating the collection scope based on the activity pattern profile for adjusting the collection scope.

9. The method as claimed in claim 6 further comprising updating the collection scope based on a geographic location for adjusting the collection scope.

10. The method as claimed in claim 6 further comprising updating the collection scope based on a user profile for adjusting the collection scope.

11. A navigation system comprising:
a factor module for determining a social indicator for identifying a social relationship;
a scope module, coupled to the factor module, for adjusting a collection scope based on the social indicator for monitoring a user's behavior;
a collection module, coupled to the scope module, for collecting a user's information based on the collection scope; and
a notification module, coupled to the collection module, for generating a notification based on the user's information for displaying on a device.

12. The system as claimed in claim 11 further comprising:
a type module, coupled to the collection module, for generating a user type based on an activity pattern profile; and
wherein:
the notification module is for customizing the notification based on the user type.

13. The system as claimed in claim 11 wherein the scope module includes an extrapolation module for extrapolating the collection scope based on a monitoring factor for adjusting the collection scope.

14. The system as claimed in claim 11 further comprising:
a pattern module, coupled to the collection module for generating an activity pattern profile based on the user's information; and
wherein:
the notification module is for customizing the notification based on the activity pattern profile for displaying on the device.

15. The system as claimed in claim 11 wherein:
the scope module includes a scope setting module for setting a collection priority; and
the collection module is for collecting the user's information based on the collection priority for generating the notification.

16. The system as claimed in claim 11 further comprising:
a pattern module, coupled to the collection module for generating an activity pattern profile based on the user's information; and
wherein:
the notification module is for generating a notification based on the activity pattern profile for displaying on a device.

17. The system as claimed in claim 16 wherein the scope module includes a scope adjuster module for adjusting the collection scope based on an another user's behavior for collecting the user's information.

18. The system as claimed in claim 16 wherein the scope module includes a scope adjuster module for updating the collection scope based on the activity pattern profile for adjusting the collection scope.

19. The system as claimed in claim 16 wherein the scope module includes a scope adjuster module for updating the collection scope based a geographic location for adjusting the collection scope.

20. The system as claimed in claim 16 wherein the scope module includes a scope adjuster module for updating the collection scope based a user profile for adjusting the collection scope.
